(19) United States
(12) Patent Application Publication
(10) Pub. No.: US 2006/0208062 A1
(43) Pub. Date: Sep. 21, 2006

(54) Injection molded gift case for debit, credit and smart cards

(76) Inventors: Warren R. Osborn, Provo, UT (US); Bryan P. Dunford, Provo, UT (US)

Correspondence Address: Angus C. Fox, III, 4093 N. Imperial Way, Provo, UT, 84604-5386, US

(21) Appl. No.: 11/082,018

(22) Filed: Mar. 16, 2005

(51) Int. Cl. G06K 5/00; G06K 7/00

(52) U.S. Cl. 235/380; 235/486

(57) ABSTRACT

A one-piece gift case for flexible plastic magnetic or smart cards is loosely patterned after digital video disc cases, in that it is of clamshell design, having a spine, front cover, and rear cover s interconnected by “living” hinges. Made preferably of polyolefins, the rear cover of the case incorporates an elevated card receptacle, which includes a generally rectangular walled recess sized to fit a card. A shoulder within the recess provides support for the edges of the card, and elevates the card from the panel that serves as the case's outer rear wall. The card is retained by a pair of protrusions molded into opposing walls of the recess. The card is installed in the recess by flexing it and sliding it beneath the protrusions. Cutouts in the other two walls of the elevated receptacle facilitate the cards removal from the recess.

### BACKGROUND OF THE INVENTION

1. Field of the Invention

The invention relates generally to gift boxes that double as protective cases for storing and carrying flexible plastic magnetic or smart cards, such as gift cards and credit cards and, more particularly to injection molded, one-piece gift boxes in which such a card can be secured.

2. History of the Prior Art

Magnetic stripe plastic cards are extensively used for credit cards, debit cards, gift cards, hotel room access and a host of other functions. Credit cards, in particular, are subjected to tremendous abuse. When carried in wallets, they are subject to constant bending, friction and abrasion. In addition, they are frequently swiped through magnetic readers. A sophisticated and complex manufacturing process has resulted in credit cards that have an expected life span of three to four years. Credit cards typically range in thickness from 0.25 mm to 0.76 mm and are typically made up of two or three layers of PVC-related polymers. Usually, one of the layers is screen printed, then a clear PVC layer is laminated on top. The printed surface, sandwiched between the two plastic sheets, typically acts as an adhesive. Solvent-based inks, though widely used, are gradually being replaced by ultraviolet-cure inks. The magnetic stripe on the back of a credit card is often called a magstripe. The magstripe is made up of tiny iron-based magnetic particles embedded in a plastic film. Each particle is really a tiny bar magnet about 20-millionths of an inch long. There are three one-tenth-inch wide tracks on the magstripe: Track one is 210 bits per inch (bpi), and holds 796-bit plus parity bit read-only characters; track two is 75 bpi, and holds 40 4-bit plus parity bit read-only characters; and track three is 210 bpi, and holds 107 4-bit plus parity bit readable and writable characters. Most banks utilize only the first two tracks. The information encoded in track one includes the primary account number, the country code, the card holder's name, and the card expiration date. The information in track two includes a repeat of the primary account number, country code and expiration date.

A smart card resembles a credit card in size and shape, but inside it is completely different. First of all, it has an inside—a normal credit card is a simple piece of plastic with a magnetic stripe. Embedded in the plastic layers of a typical smart card is an entire computer system, including an 8-bit microprocessor, up to 1 kilobyte of random-access memory (RAM), 24 kilobytes of read-only memory (ROM), and 16 kilobytes of programmable ROM. The function of the microprocessor on the smart card is to limit access to data on the card. Through a card reader, a host computer communicates with the embedded computer system. The smart card uses a serial interface and receives its power from external sources like a card reader. The processor uses a limited instruction set for applications such as cryptography. The microprocessor is under a gold contact pad on one side of the card. Although in widespread usage in other parts of the world, the popularity of smart cards is just now beginning to take off in the United States. The most common smart card applications are: credit cards, electronic cash, computer security systems, wireless communication, loyalty systems (e.g., frequent flyer points), banking, satellite TV, and government identification. Smart cards incorporating a radio-frequency identification (RFID) device may be interrogated that is not in intimate contact with the card. The RFID device is usually a passive (having no on-board power source, such as a battery) and generally includes an on-board antenna and an application specific integrated circuit (ASIC). The RFID device receives its operational energy from a reader device, which must be in close proximity. Within what is termed the surveillance zone, the reader generates sufficient power to excite, or interrogate, the RFID device. When radio frequency energy emanating from the reader antenna impinges on the RFID device, a current is induced in on-board antenna. This induced current is routed to the ASIC, which then performs an initialization sequence. When the reader ceases transmitting its energy transmitting interrogation signal, the ASIC begins to broadcast its identity and any other requested information over the on-board antenna. The transmission process utilizes low-energy transmission technology that selectively reflects the electromagnetic energy back to the reader at the same fundamental frequency as it was received, using the on30 board antenna as an energy radiator. The transmit/receive frequency employed is generally application dependent. Commonly available proximity interrogation systems operate at frequencies in a range of 60 kHz to 5.8 GHz, and typically employ frequency modulation for data transmission. Information reflected by RFID device is decoded by the reader.

Gift cards, whether in the form of a magnetic card or a smart card, have become immensely popular among retailers and the buying public. Gift cards function like a debit card. Purchased by a donee using cash or credit, an account is set up in the retailer's computer system for the amount tendered by the donee. The retailer then issues a card, which identifies the account and the tendered amount. After the card is transferred to a beneficiary, the beneficiary can pay for purchases, up to the account total, using the gift card. The purchase of a gift card is the equivalent of a no-interest loan made to the retailer by the donee. If the beneficiary loses or forgets about the card, the purchase will represent a gift to the retailer!

Although a gift card may represent any amount of tendered value—up to hundreds or even thousands of dollars in value, the card does not, in an of itself, make a very impressive gift. In the first place, a 3.375-inch×2.125-inch×0.030-inch thick piece of plastic is not particularly impressive. It also, most likely, represents a last minute gift decision on the part of the donee. In response to this phenomenon, the packaging industry has created a plethora of impressive gift boxes for delivery of the gift cards.

### SUMMARY OF THE INVENTION

A primary object of the present invention is to provide a one-piece, injection-molded case for gifting, storing and carrying flexible plastic magnetic or smart cards. Collectively, such cards shall be referred to herein as “transaction cards”. The case, which shall be referred to herein simply as a “gift case”, is loosely patterned after a conventional case for digital video discs (DVDs), in that it is has a spine which is interconnected to a front cover and a rear cover by a pair of what are known as “living” or “live” hinges. A living hinge is a thin flexible web of material that joins two rigid or semi-rigid bodies together. The gift case is preferably made of a medium-density polyolefin, such as polypropylene or polyethylene, as both of these materials have excellent flexural qualities that permit a living hinge to be flexed thousands of times without breaking. If the hinge is not expected to last forever, other polymeric compounds, such as nylon and acetal may be used. The present invention differs markedly from a conventional DVD case in that the rear cover of the gift case includes an elevated card receptacle that is unitary with the gift case. The card receptacle includes a generally rectangular walled recess sized to fit a gift or credit card. Four, generally perpendicular intersecting walls form the recess. The walls incorporate a shoulder below the top edges thereof, which supports the edges of the transaction card and elevates it above a laminar rear panel that provides an exterior surface for the rear cover of the gift case. The card is retained in the recess by a pair of protrusions which are molded into opposing walls of the recess. The card is most easily inserted in the recess by flexing the card, sliding it beneath the protrusions, and allowing the card to retain its planar configuration when it is positioned completely within the recess. The elevated card receptacle incorporates a pair of cutouts positioned at opposite ends of the rectangular recess and on the walls of the rectangular recess that connect the walls having the card retention protrusions. The cutouts enable the card owner to slip a finger beneath one end of the card, flex the card, and slide it out of the recess. Optionally, a flexible transparent plastic sleeve may be heat sealed to the outer surface of the gift case so that a decorative paper or plastic film insert may be inserted between the sleeve and the injection-molded of the gift case. This feature is common to DVD cases, and allows printed title and credit information to be installed on the case.

### BRIEF DESCRIPTION OF THE DRAWING

FIG. 1 is a plan view of the outer major surfaces of the open one-piece gift case;

FIG. 2 is a plan view of the inner major surfaces of the open one-piece gift case;

FIG. 3 is an elevational view of the top edge of the open one-piece gift case;

FIG. 4 is an elevational view of the open one-piece gift case, as seen from the closure edge of the rear cover closure;

FIG. 5 is an elevational view of the open one-piece gift case, as seen from the closure edge of the front cover;

FIG. 6 is an elevational view of the bottom edge of the open one-piece gift case;

FIG. 7 is a cross-sectional view of the open one-piece gift case, than through section line 7-7 of FIG. 2;

FIG. 8 is a cross-sectional view of the open one-piece gift case, taken through section line 8-8 of FIG. 2;

FIG. 9 is a plan view of the closed one-piece gift case, looking down at the front cover;

FIG. 10 is a plan view of the closed one-piece gift case, looking down at the rear cover;

FIG. 11 is an elevational view of the spine of the closed one-piece gift case;

FIG. 12 is an elevational view of the closure edges of the closed one-piece gift case;

FIG. 13 is an elevational view of the top edge of the closed one-piece gift case;

FIG. 14 is an elevational view of the bottom of the closed one-piece gift case; and

FIG. 15 is a plan view of an open one-piece gift case, showing a gift card inserted within the recess.

### DETAILED DISCLOSURE OF THE INVENTION

The present invention is a one-piece, injection-molded gift case for flexible plastic magnetic or smart cards, that doubles as a protective container for storing and carrying the card. Patterned loosely after a conventional case for digital video discs (DVDs), it is of clamshell design, having a spine connected to both a front cover and a rear cover via a pair of “living” or “live” hinges. A living hinge is a thin flexible web of material that joins two rigid or semi-rigid bodies together. The gift case is preferably made of a medium-density polyolefin, such as polypropylene or polyethylene, as both of these materials have excellent flexural qualities that permit a living hinge to be flexed thousands of times without breaking. If the hinge is not expected to last forever, other polymeric compounds, such as nylon and acetal may be used. The present invention differs markedly from a conventional DVD case in that the rear cover of the case incorporates an elevated card receptacle. The card receptacle includes a generally rectangular walled recess sized to fit a gift or credit card. The one-piece gift card case will now be described in detail with reference to the attached drawing figures.

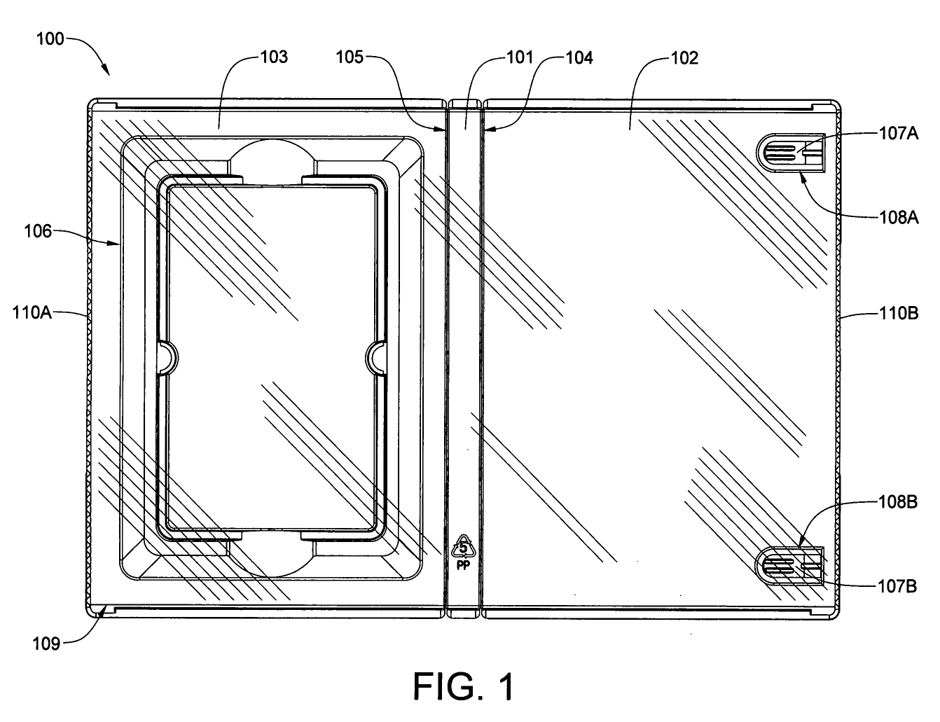

Referring now to FIG. 1, the one-piece injection-molded gift case 100 has a spine 101, a generally rectangular front cover 102 and a generally rectangular rear cover 103. A first living hinge 103 interconnects the spine 101 with the front cover 102, and a second living hinge 104 interconnects the spine 101 with the rear cover 103. The rear cover 103 incorporates an elevated card receptacle, which is seen here only as a rectangular, recessed channel 105 in the rear cover 103. A pair of internal clips 106A and 106B, which can be used to secure a greeting card inside the front cover 102 of the case 100, can be seen through apertures 107A and 107B in the front cover 102 that were required by the molding process. An optional sleeve 108, made of transparent flexible plastic material may be heat bonded to the outermost exterior edges 109A and 109B of the case. A paper or plastic sheet containing a graphic design or identifying material may be inserted within the sleeve.

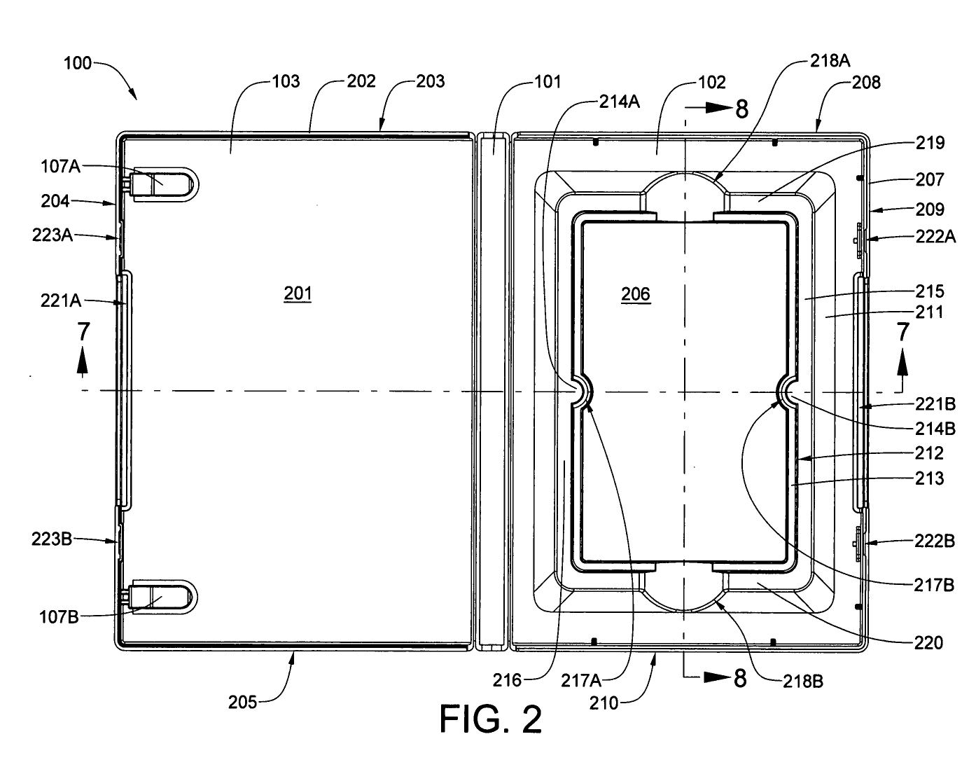

Referring now to FIG. 2, the features within the interior of the gift case 100 are readily visible. The front cover 102 includes a generally laminar front panel 201 and a front, half-height closure wall 202 that is generally perpendicular to said laminar front panel 201, and continuous with a top lateral front edge 203, an outer longitudinal front edge 204, and a bottom lateral front edge 205. The tops of the internal clips 106A and 106B can also be seen in this view. The rear cover 103 also includes a generally laminar rear panel 206 and a rear, half-height closure wall 207 that is generally perpendicular to said laminar rear panel 206, and continuous with a top lateral rear edge 208, an outer longitudinal rear edge 209, and a bottom lateral rear edge 210. An elevated card receptacle 211 is integral with the generally laminar rear panel 206, and extends upwardly from the inner surface of the rear panel 206. The card receptacle 211 includes a generally rectangular walled recess 212 sized to fit a gift or credit card. A shoulder 213 within the recess 212 provides support for the edges of the card, and elevates the card from the rear panel 206. The card is retained by a pair of protrusions 214A and 214B molded into opposed walls 215 and 216 of the recess 212. Below each protrusion 214A or 214B is an aperture 217A and 217B, respectively, that is required by the molding process. The card is installed in the recess 212 by flexing it and sliding it beneath the protrusions 214, and then allowing it to retain its planar configuration when it is positioned completely within the recess 212. The elevated card receptacle 211 also incorporates a pair of cutouts 218A and 218B that positioned at opposite ends of the rectangular recess and on the other pair of opposed walls 219 and 220 of the rectangular recess 212. The cutouts 218A and 218B enable the card owner to slip a finger beneath one end of the card, flex the card, and slide it out of the recess. The cutouts 218A and 218B break the continuity of the shoulder 213. Both the front cover 102 and the rear cover 103 each have a recess 221A and 221B along their respective closure edges 104 and 109. When the case 100 is closed, this recess enables the owner to open the case 100 by prying the closure edges 104 and 109 apart. The rear cover 103 has a pair of male case latches 222A and 222B, while the front cover 102 has a pair of female case latches 223A and 223B. Each male case latch snaps into its mating female case latch.

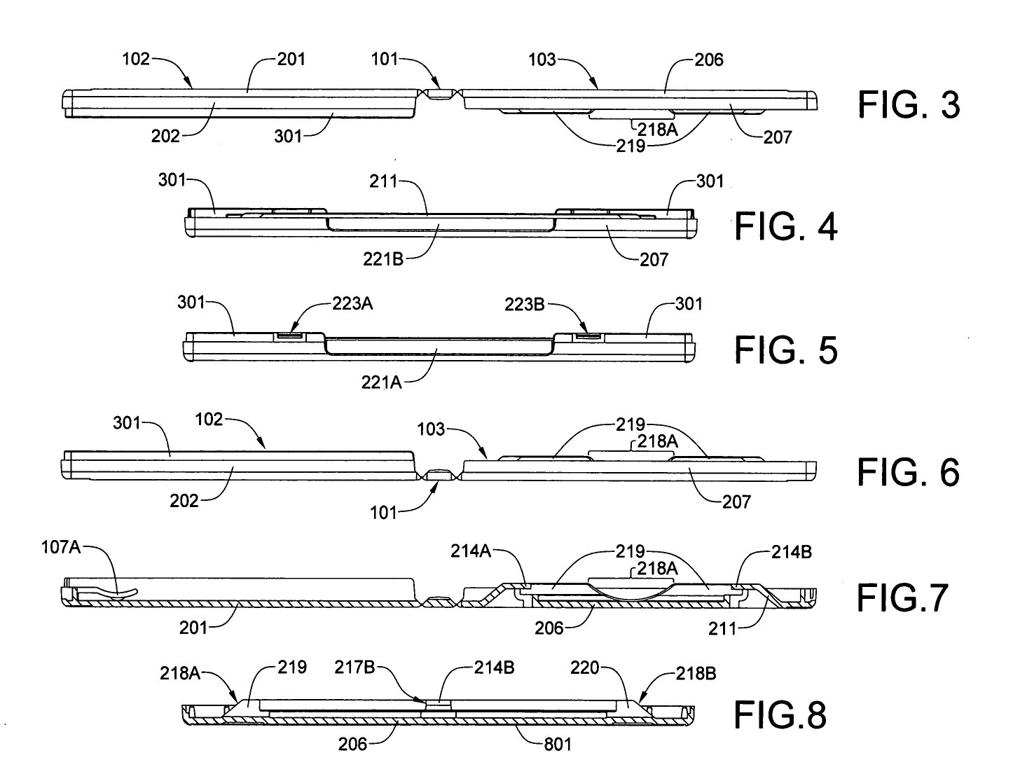

Referring now to FIGS. 3, 4, 5, and 6, the open gift case 100 is seen in a variety of elevational views. Item numbers for various features correspond with those of FIGS. 2 and 3.

Referring now to the cross-sectional view of FIG. 7, the open one-piece gift case, the profiles of the front panel 201 and the rear panel 206 are readily visible, as is the profile of the elevated card receptacle 211. In this view, it can be seen that the rear panel 206 is integral with the elevated card receptacle 211, although the aperture 217A or 217B below each of the protrusions 214A and 214B, respectively, breaks the continuity of the cross-section.

Referring now to the cross-sectional view of FIG. 8, protrusion 217B is visible in this view, as is the aperture 217B, and the profile of the shoulder 213.

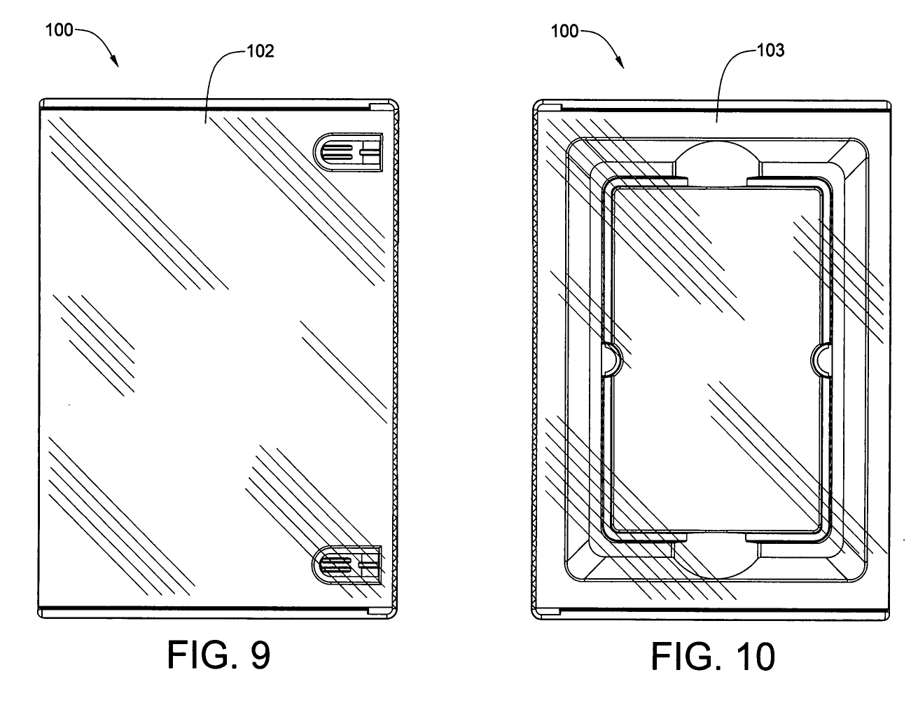

Referring now to FIG. 9, it will be noted that when the one-piece gift case 100 is closed, the spine 101 fits neatly into the front cover 102. The pair of internal clips 106A and 106B are visible in this view through apertures 107A and 107B, respectively. Slightly less than half of the transparent flexible plastic sleeve 108 is also visible in this view.

Referring now to FIG. 10, the underside of the elevated card receptacle 211 is visible in this view, and takes the form of a rectangular trench 1001. Again, slightly less than half of the transparent flexible plastic sleeve 108 is visible in this view.

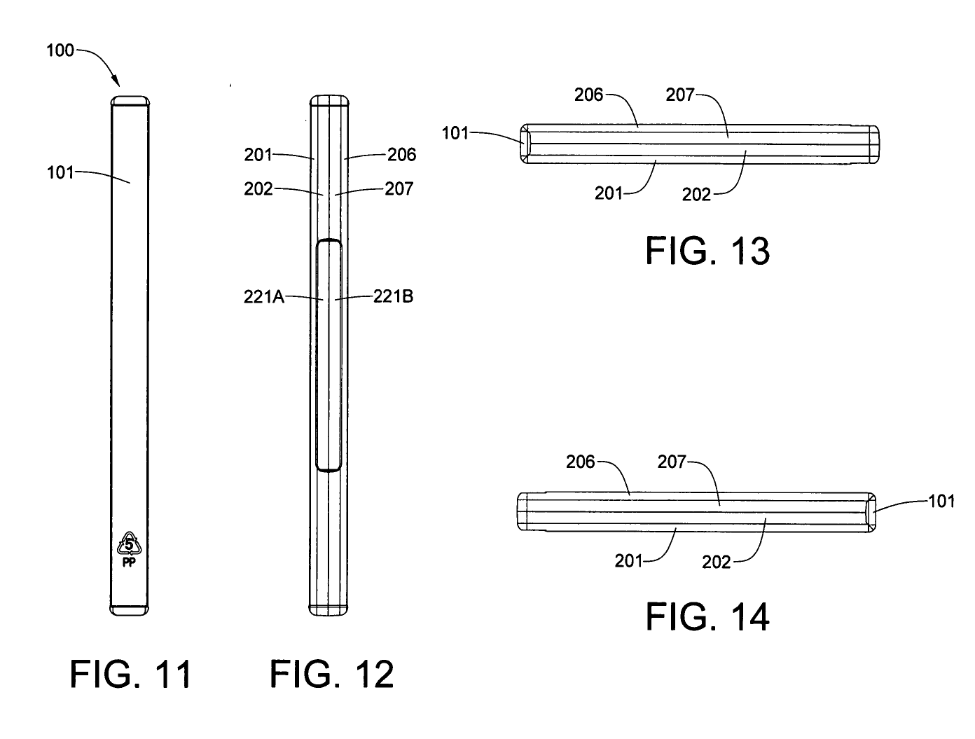

Referring now to FIGS. 11, 12, 13 and 14, the closed one-piece gift case 100 is seen in a variety of elevational views. Item numbers for various features correspond with those of FIGS. 2 and 3.

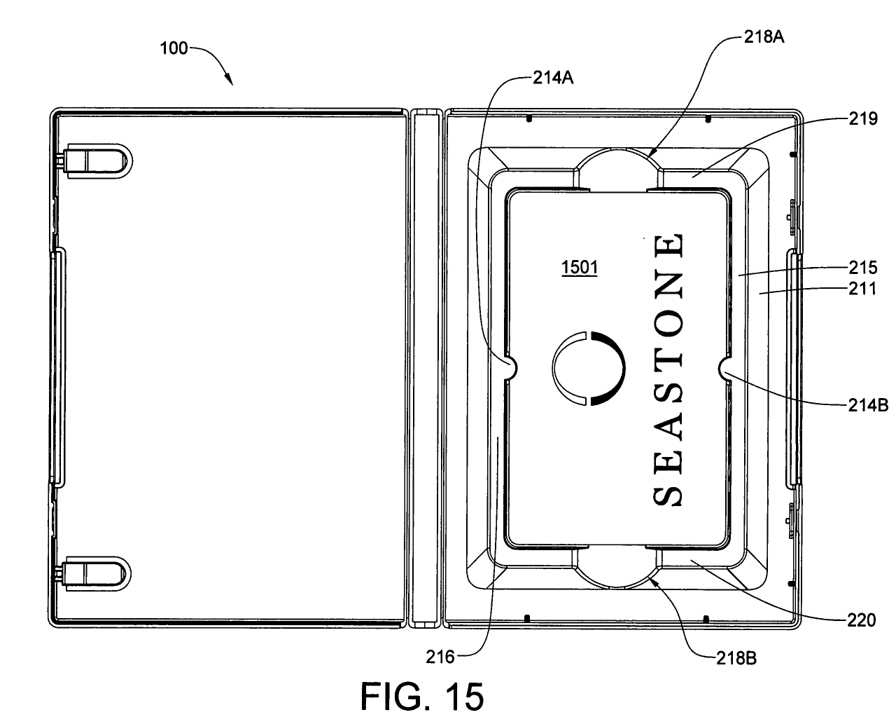

Referring now to FIG. 15, the open one-piece gift case 100 is shown with a gift card 1501 inserted within the generally rectangular walled recess 212. It will be noted that the protrusions 217A and 217B overhang the longitudinal edges 1502A and 1502B of the card.

Although only a single embodiment of the present invention has been disclosed herein, it will be obvious to those having ordinary skill in the art that changes and modifications may be made thereto without departing from the scope and spirit of the invention as hereinafter may be claimed.

1. A one-piece, injection-molded case for gifting, storing and carrying flexible plastic transaction cards, said case comprising:
a spine;
a front cover coupled to said spine via a first living hinge; and
a rear cover coupled to said spine via a second living hinge, said rear cover incorporating an internally elevated card receptacle having a generally rectangular walled recess sized to fit a flexible plastic transaction card, said rectangular walled recess being equipped with at least one shoulder, on which the lower edges of an installed transaction card rest, said walled recess further having a single protrusion on each of a first pair of opposed walls of said recess, said protrusions serving to retain said transaction card within said walled recess.

2. (canceled)

3. The one-piece, injection-molded case of claim 2, wherein said standard dimensions are about 3.375 inches by 2.125 inches (8.573 cm by 5.715 cm).

4. (canceled)

5. (canceled)

6. The one-piece, injection-molded case of claim 1, wherein a material from which it is injection molded is a polyolefin.

7. The one-piece, injection-molded case of claim 6, wherein said polyolefin is selected from the group consisting of polyethylene and polypropylene.

8. The one-piece, injection-molded case of claim 1, wherein said spine is generally perpendicular to said front cover and said rear cover when said case is closed.

9. The one-piece, injection-molded case of claim 1, wherein outer surfaces of said spine, said front cover, and said rear cover generally lie in a common plane when the case is open.

10. The one-piece, injection-molded case of claim 1, wherein said receptacle includes a cutout on each of a second pair of opposing walls of said rectangular walled recess, said cutouts enabling a card owner to slip a finger beneath one end of the card, flex the card, and slide it out of the recess.

11. In combination with the one-piece, injection-molded case of claim 1, a flexible transparent polymeric plastic sleeve that is heat sealed to an outer surface of said case, so that a decorative or descriptive paper or plastic film insert may be inserted between the sleeve and the case.

12. A one-piece case for gifting, storing and carrying flexible plastic transaction cards, said case comprising:
a generally rectangular spine having a pair of opposed lateral edges and first and second opposed longitudinal edges;
a generally rectangular front cover having
a generally laminar front panel having exterior and interior surfaces with a pair of opposed lateral edges and a pair of opposed longitudinal edges;
a front half-height closure wall generally perpendicular to said laminar front panel, continuous with the lateral edges and one longitudinal edge of said front panel, and extending upwardly from the interior surface of said front panel, said remaining longitudinal edge of said front panel being coupled to the first longitudinal edge of said spine via a first living hinge; and
a generally rectangular rear cover having
a generally laminar rear panel having exterior and interior surfaces with a pair of opposed lateral edges and a pair of opposed longitudinal edges;
a rear half-height closure wall generally perpendicular to said laminar rear panel, continuous with both lateral edges and one longitudinal edge, and extending upwardly from the interior surface of said rear panel, said remaining longitudinal edge of said rear panel being coupled to the second longitudinal edge of said spine via a second living hinge; and
a card receptacle having a generally rectangular walled recess sized to fit a flexible plastic transaction card of standard dimensions, said card receptacle extending upwardly from the interior surface of said rear panel, said card receptacle being continuous with said rear panel, said rectangular walled recess being equipped with at least one shoulder, on which the lower edges of an installed transaction card rest, said walled recess further having a single protrusion on each of a first pair of opposed walls of said recess, said protrusions serving to retain said transaction card within said walled recess.

13. The one-piece case of claim 12, wherein said spine is generally perpendicular to said front panel and said rear panel, and said front and rear half-height closure walls in intimate contact when said case is closed.

14. The one-piece case of claim 12, wherein said spine, said front panel and said rear panel generally lie in a common plane when the case is open.

15. The one-piece case of claim 12, wherein said standard dimensions are about 3.375 inches by 2.125 inches (8.573 cm by 5.715 cm).

16. (canceled)

17. (canceled)

18. The one-piece case of claim 17, wherein said receptacle includes a cutout on each of a second pair of opposing walls of said rectangular walled recess, said cutouts enabling a card owner to slip a finger beneath one end of the card, flex the card, and slide it out of the recess.

19. The one-piece case of claim 12, wherein said case is injection molded from a polyolefin material.

20. The one-piece case of claim 19, wherein said polyolefin material is selected from the group consisting of polyethylene and polypropylene.
